(19) United States
(12) Patent Application Publication
(10) Pub. No.: US 2004/0075295 A1
(43) Pub. Date: Apr. 22, 2004

(54) Energy absorbing impact deflector for use in vehicle doors

(76) Inventor: Glen D. Schmidt, New Baltimore, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/272,750

(22) Filed: Oct. 17, 2002

(51) Int. Cl. B60J 5/04

(52) U.S. Cl. 296/146.6

(57) ABSTRACT

A combination energy absorption and environmental insulating barrier incorporated into a vehicle door assembly, the assembly including an assembleable trim pad. A three dimensional structural component has a specified length, width and thickness and with at least one impact absorbing portion being designed into the structural component. A plurality of projections and recesses are defined in at least one of first and second faces of the structure component, the component further being molded into the desired three dimensional shape using an impact absorbing material. A moisture impervious barrier is placed upon an inner face of the trim pad and the structural component is adapted to being secured to an inner face of the trim pad and prior to installation of the trim pad against an opposing and inner facing side of the vehicle door.

### BACKGROUND OF THE INVENTION

1. Field of the Invention

The present invention relates generally to both impact resistant barriers for incorporation into a vehicle door, as well as water, dust and sound barrier applications. More particularly, the present invention is a three dimensional molded and structural (component supporting) article incorporated between a vehicle door and covering trim pad, and which provides the combined aspects of environmental (water, dust and sound) protection as well as side impact deflection.

2. Description of the Prior Art

The prior art is well documented with examples of door mounted and energy impacting modules and the like. A first example of this is illustrated in U.S. Pat. No. 5,308,138, issued to Hlavaty, and which teaches a support frame cartridge mounted between inner and outer door panels and including push-on mounting studs for mounting a pair of energy-absorbing pads. Notches provided in the belt line cross member better utilize the energy-absorbing pads, thus increasing the dynamic side impact protection to an occupant of the vehicle. The energy absorbing members are further disclosed as being constructed of sheets or panels of closed-cell polystyrene foam.

U.S. Pat. No. 6,197,403, issued to Brown, teaches an integral sound absorber and water deflector door panel having a first polymeric and water impervious layer and a second polymeric foam layer. An outer face of the second polymeric layer contacts a portion of the exteriorly oriented face of the passenger compartment door. The thickness of the first polymeric layer of the integral door panel is further uniform through the part, while the thickness of the second polymeric layer varies positionally to conform the dimensional requirements of the surrounding door assembly and specific vibrational and noise abatement requirements of the given door assembly and associated automotive vehicle.

U.S. Pat. No. 6,233,875, issued to Carlo, teaches a sealed module for a vehicle door including a rigid peripheral part and a plate connected on its periphery and in a sealed manner to the rigid peripheral part and filling the area defined by the latter. The plate is further disclosed as being composed of a cheap material which reduces the cost of the module while maintaining its mechanical properties on the peripheral part. A device, such as a window winding mechanism, is fixed to the rigid part.

Additional references of note include U.S. Pat. No. 6,062,624, issued to Crabtree, which teaches a sealing acoustical baffle and method and by which a sealing material fills a cavity of a pillar or other body member of a vehicle. Salmonowicz et al. 5,762,394 teaches a vehicle door with structural plastic inner panel. Bradac 5,482,343 teaches a vehicle door and water deflector including a plastic water deflector sheet positioned between the trim panel and the inner door panel.

Finally, U.S. Pat. No. 5,456,513, issued to Schmidt, discloses a sound, water and dust barrier having a laminated body with a central layer composed of a filled plastic which provides sound dampening characteristics to the water barrier. Additional outer layers of an unfilled plastic sandwich about the central layer. Vacuum formed speaker recesses or like contoured shapes may be provided for accommodating suitable components and flexible clip pockets are sealingly attached about openings in the body to allow the water barrier to be clipped to the inner and outer door panels of the vehicle door. An adhesive and release agent may be applied on the opposing outer layers and, in the preferred application, the center and outer layers are coextruded together.

### SUMMARY OF THE PRESENT INVENTION

The present invention discloses a three dimensional molded and structural (component supporting) article incorporated between a vehicle door and covering trim pad, and which provides the combined aspects of environmental (water, dust and sound) protection as well as side impact deflection. In particular, the present invention combines the technology of current environmental door barriers, with the technology associated with side impact blocks, into an integral and three dimensional construction which is installed into a vehicle trim pad and prior to subsequent installation of the trim pad into the inner facing metal of the vehicle door. A furthering advantage of pre-installing the molded and structural component into the trim pad is to facilitate installation of additional sound blocking and absorbing materials, wiring harnesses, wire harness attachment devices, speakers, speaker attachment devices and other seals and components, thus reducing the number of parts entering the assembly plants.

The structural component exhibits a specified length, width and thickness and is constructed of a suitable energy absorbing structural foam, such as possibly including a urethane or an impact resistant styrene. In the preferred application, the structural component is constructed in a suitable molding operation and to include both the provision of varying projections and recesses on one or both faces thereof, at least one aperture formed therethrough, and as well as the configuration of impact absorbing portions defined at selected locations.

The vehicle assembly includes both a structural door and a trim pad (fascia) securable in opposing manner against an inner facing side of the door. In a first step of a preferred assembly operation, a moisture impervious barrier is applied upon the inner face of the trim pad, and prior to the installation of the three dimensional structural component. The trim pad, incorporating the pre-installed structural barrier, is then shipped by the trim pad manufacturer to the vehicle assembler. Additional components, such as previously recited and again including one or more of an acoustic blocking material, acoustic absorbing material, gaskets, seals, clips, brackets, wiring harnesses, wire harness attachment devices, speakers, speaker attachment devices, motors, handles, lock rods, air bags, and seals are capable of being installed into the structural component either before or during its attachment to the door trim pad and so that a completed subassembly can be shipped to the vehicle assembler for final installation.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an exploded perspective view of the combination energy absorption and environmental insulating barrier integrated between the vehicle door and associated trim pad and according to a preferred embodiment of the present invention;

FIG. 2 is further perspective view, in partial cutaway fashion, of an inner facing side of the three dimensional and molded structural component according to the present invention and over which is installed the vehicle trim pad; and

FIG. 3 is a 180° rotated perspective view of the structural component and illustrating an opposite and outer facing side which is nestingly received within the associated and inner facing side of the vehicle door.

### DETAILED DESCRIPTION OF THE PREFERRED EMBODIMENTS

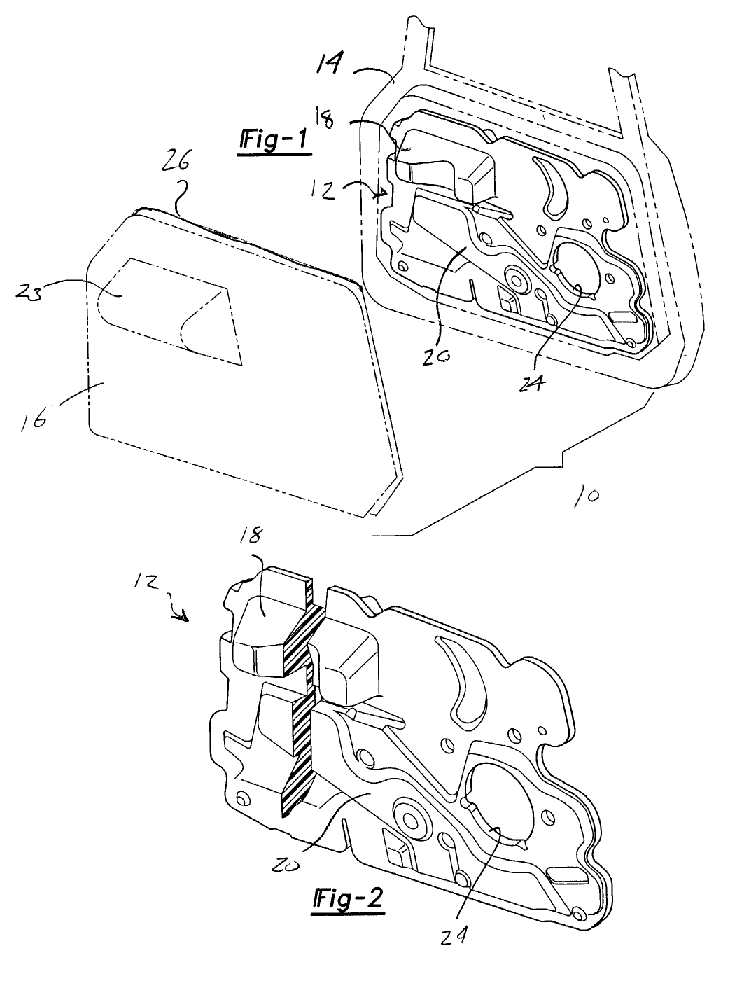

Referring now to FIG. 1, a vehicle door assembly is illustrated at 10 according to the present invention and by which a combination energy absorption and environmentally insulating barrier 12 is incorporated between a vehicle door 14 and an associated and overlaying trim pad 16. As described previously, the present invention provides the combined aspects of environmental (water, dust and sound) protection as well as side impact deflection. In particular, the present invention combines the technology of current environmental door barriers, with the technology associated with side impact blocks, into an integral and three dimensional construction, see again at 10, which is installed into the vehicle trim pad 16 and prior to subsequent installation of the trim pad 16 into the inner facing metal (see again FIG. 1) of the vehicle door 14.

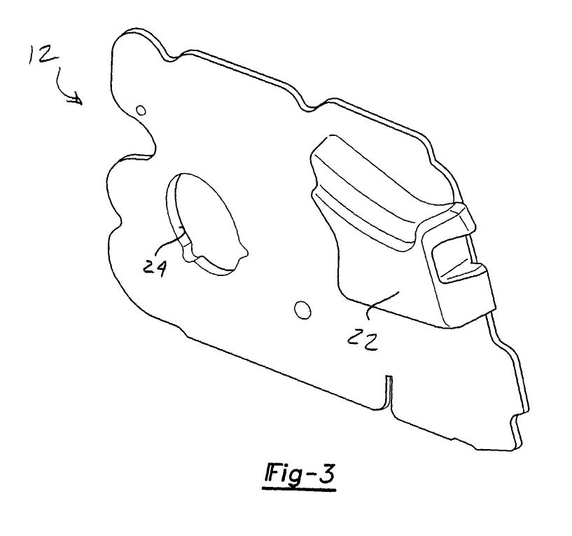

Referring again to FIG. 1, as well as to FIG. 2, the barrier 12 is provided as a three dimensional structural component exhibiting a specified length, width and thickness corresponding generally to the outline of the associated vehicle door 14 and which is constructed of a suitable energy absorbing structural foam (see again cutaway portion in FIG. 2), such as potentially including a urethane or an impact resistant styrene. In the preferred application, the structural component is constructed in a suitable molding operation and to include both the provision of varying projections and recesses, such as at 18 for armrest portion and at 20 for structural beam portion. Referring also to the rotated view of FIG. 3, additional projections include the provision of a reinforcing (impact absorbing) portion 22 associated with a reverse facing side of the armrest portion (see also at 23 for trim pad 16) and which is nestingly received within the inner facing configuration of the vehicle door 14, as well as at least one aperture, see for example inner annular surface 24, formed therethrough.

As illustrated and described, the vehicle assembly again includes both the structural door 14 and associated trim pad 16 (fascia) securable in opposing manner against an inner facing side of the door. In a first step of a preferred assembly operation, a moisture impervious barrier 26 is applied upon the inner face of the trim pad, and prior to the installation of the three dimensional structural component 12. An additional seal, not shown, may further be designed to seal the three dimensional structural component (barrier) 12 to the door 14 during the normal installation of the trim pad, thus decreasing the labor required on the assembly line. The trim pad 16, now incorporating the pre-installed structural barrier and combining into one piece both the side impact and environmental resistant aspects, is then shipped by the trim pad manufacturer to the vehicle assembler for final assembly.

It is also contemplated that additional components, such as previously recited and again including one or more of an acoustic blocking material, acoustic absorbing material, gaskets, seals, clips, brackets, wiring harnesses, wire harness attachment devices, speakers, speaker attachment devices, motors, handles, lock rods, air bags, and seals are capable of being installed into the structural component 12 either before or during its attachment to the door trim pad 16 and so that a completed subassembly can be shipped to the vehicle assembler for final installation into the vehicle door 14. It has been found that the structural integrity inherently derived from the barrier/structural component 12 makes possible the affixation or incorporation of the various components and accessories, this not previously having been possible with earlier and less robust barrier designs. In this manner, the number of parts needed for assembly is reduced.

Having described my invention, additional preferred embodiments will become apparent to those skilled in the art to which it pertains and without deviating from the scope of the appended claims.

I claim:

1. A combination energy absorption and environmental insulating barrier incorporated into a vehicle door assembly, said barrier comprising:
a three dimensional structural component having a specified length, width and thickness; and
at least one impact absorbing portion being designed into said structural component, said component being molded into said three dimensional shape using an impact absorbing material.

2. The energy absorbing and environmentally insulating barrier according to claim 1, the vehicle door assembly including an assembleable trim pad, said three dimensional structural component adapted to being secured to an inner face of the trim pad and prior to installation of the trim pad against an opposing and inner facing side of the vehicle door.

3. The energy absorbing and environmentally insulating barrier according to claim 1, further comprising a moisture impervious barrier pre-placed upon the inner face of the trim pad prior to securing of said three dimensional structural component.

4. The energy absorbing and environmentally insulating barrier according to claim 1, further comprising a plurality of projections and recesses defined in at least one of first and second faces of said structural component.

5. The energy absorbing and environmentally insulating barrier according to claim 4, further comprising at least one aperture formed through said structural component.

6. The energy absorbing and environmentally insulating barrier according to claim 5, said structural component incorporating at least one of an acoustic blocking material, acoustic absorbing material, gaskets, seals, clips, brackets, wiring harnesses, wire harness attachment devices, speakers, speaker attachment devices, motors, handles, lock rods, air bags, and seals.

7. The energy absorbing and environmentally insulating barrier according to claim 1, further comprising said three dimensional structural component being constructed of an energy absorbing structural foam.

8. The energy absorbing and environmentally insulating barrier according to claim 7, further comprising said structural component being constructed of at least one of a urethane and an impact resistant styrene.

9. A combination energy absorption and environmental insulating barrier incorporated into a vehicle door assembly, the assembly including an assembleable trim pad, said barrier comprising:
a three dimensional structural component having a specified length, width and thickness, at least one impact absorbing portion being designed into said structural component, a plurality of projections and recesses defined in at least one of first and second faces of said structure component, said component being molded into said three dimensional shape using an impact absorbing material;
a moisture impervious barrier placed upon an inner face of the trim pad;
said structural component adapted to being secured to an inner face of the trim pad and prior to installation of the trim pad against an opposing and inner facing side of the vehicle door.

10. The energy absorbing and environmentally insulating barrier according to claim 9, further comprising at least one aperture formed through said structural component.

11. The energy absorbing and environmentally insulating barrier according to claim 10, said structural component incorporating at least one of an acoustic blocking material, acoustic absorbing material, gaskets, seals, clips, brackets, wiring harnesses, wire harness attachment devices, speakers, speaker attachment devices, motors, handles, lock rods, air bags, and seals.

12. The energy absorbing and environmentally insulating barrier according to claim 9, further comprising said three dimensional structural component being constructed of an energy absorbing structural foam.

13. The energy absorbing and environmentally insulating barrier according to claim 12, further comprising said structural component being constructed of at least one of a urethane and an impact resistant styrene.
